(19) United States
(12) Patent Application Publication
(10) Pub. No.: US 2018/0071664 A1
(43) Pub. Date: Mar. 15, 2018

(54) FILTER FOR LIQUIDS, IN PARTICULAR FOR ELECTRIC VALVES OF HOUSEHOLD APPLIANCES AND THE LIKE

(71) Applicant: ELBI INTERNATIONAL S.p.A., Torino (IT)

(72) Inventors: Paolo RAVEDATI, Moncalieri (Torino) (IT); Fabrizio GONELLA, Cambiano (Torino) (IT); Francesco DI BENEDETTO, Grugliasco (Torino) (IT); Maurizio RENDESI, Villarbasse (Torino) (IT)

(73) Assignee: ELBI INTERNATIONAL S.p.A., Torino (IT)

(21) Appl. No.: 15/818,922

(22) Filed: Nov. 21, 2017

Related U.S. Application Data
(63) Continuation of application No. 13/877,804, filed on Apr. 4, 2013.

(30) Foreign Application Priority Data
Oct. 5, 2010 (IT) TO2010A000808

(51) Int. Cl. B01D 35/02

(52) U.S. Cl. CPC B01D 35/02; B01D 35/023

(57) ABSTRACT

A conduit with a filter (1) having a body of moulded plastic material, including a central hollow portion (3) shaped like a cup, having an axis (A-A), and a peripheral plate-like portion (4), shaped as an annular flange, extending radially toward the outside around the open end of the central cup-shaped portion (3), wherein in the lateral wall (3a) of the central cup-shaped portion (3) there is provided a plurality of through holes (6), essentially transverse with respect to the axis (A-A), and in the peripheral flange-like portion (4) there is provided a plurality of through holes (5) essentially parallel to the axis (A-A).

### CROSS-REFERENCE TO RELATED APPLICATIONS

This application is a continuation of U.S. Ser. No. 13/877,804 filed on Apr. 4, 2013, which is National Stage of International Application No. PCT/IB2011/054387 filed Oct. 5, 2011, claiming priority based on Italian Patent Application No. TO2010A000808 filed Oct. 5, 2010, the contents of all of which are incorporated herein by reference in their entirety.

### BACKGROUND OF THE INVENTION

### Field of the Invention

The present invention relates to a filter for liquids, and in particular an inlet filter for a hydraulic electric valve for household appliances and the like.

### Background

More specifically, the invention relates to a filter for liquids which is of the type including a body of moulded plastic material having at least one wall which has a plurality of holes designed for the passage of a flow of liquid.

One object of the present invention is to provide an improved filter for liquids of the type defined above.

### SUMMARY OF THE INVENTION

This and other objects are achieved according to the invention with a filter for liquids of the type defined above, comprising:
a central hollow portion shaped like a cup, having an axis, and
a peripheral plate-like portion, shaped as a flange, extending radially towards the outside around the open end of the central cup-shaped portion, and wherein
in the lateral wall of the central portion there is provided a plurality of through holes, essentially transverse with respect to the axis, and in the peripheral portion there is provided a plurality of through holes essentially parallel to the axis.

Conveniently, for use in a conduit having a predetermined average transverse radial dimension, the central portion of the filter has an average transverse radial dimension comprised between about 0.45 and about 0.8 times the average transverse radial dimension of the conduit.

Additionally, the axial length of the central portion of the filter is conveniently greater than or equal to about 0.7 times the average radial dimension of the conduit.

These ranges of values enable the behaviour of the filter to be optimized, as will be explained more fully below.

According to a further advantageous characteristic, the holes provided in the lateral wall of the central portion of the filter are all parallel to each other.

Because of this characteristic, only two moving carriages are required for moulding the lateral wall of the central cup-shaped portion. The moulding equipment is therefore considerably simplified.

### BRIEF DESCRIPTION OF THE DRAWINGS

Other characteristics and advantages of the invention will become clear from the following detailed description which is given purely by way of non-limiting example with reference to the attached drawings, in which:

FIG. 1 is a perspective view showing a filter for liquids according to the present invention and two movable carriages of the moulding equipment for forming the lateral wall of the central cup-shaped portion of the filter;

FIG. 2 is a front view of the filter and of the moulding devices shown in FIG. 1;

FIG. 3 is a partial perspective view showing part of the filter according to the preceding drawings and an associated moulding device;

FIG. 4 is a schematic representation in axial section of a conduit provided with a filter according to the invention, and

FIG. 5 is a diagram illustrating characteristics of a filter of this kind.

### DETAILED DESCRIPTION OF THE INVENTION

In the drawings, the number 1 indicates the whole of a filter for liquids according to the present invention.

The filter 1 is, for example, an inlet filter for a hydraulic electric valve for use in a household appliance or the like.

In the embodiment shown by way of example, the filter 1 comprises a body 2 of moulded plastic material.

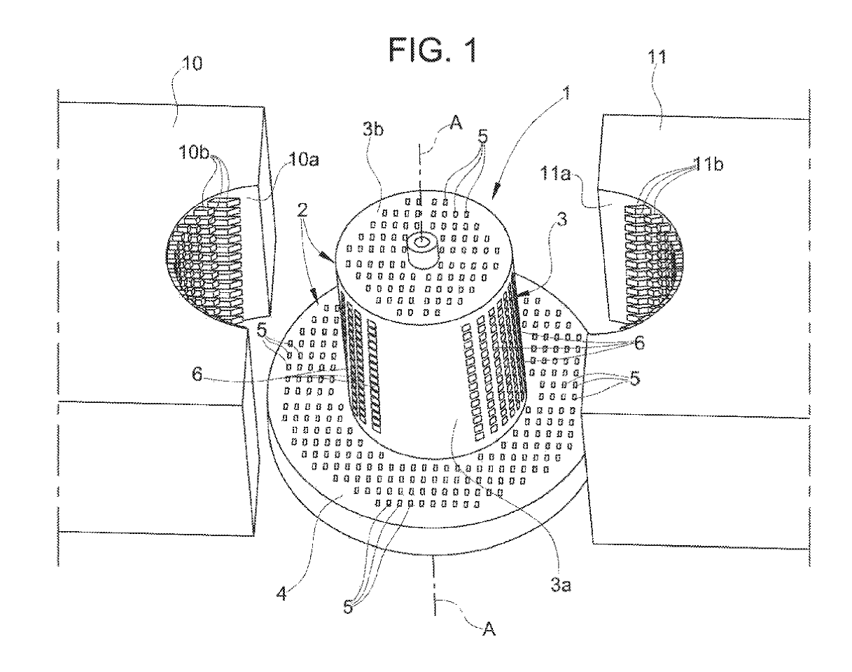

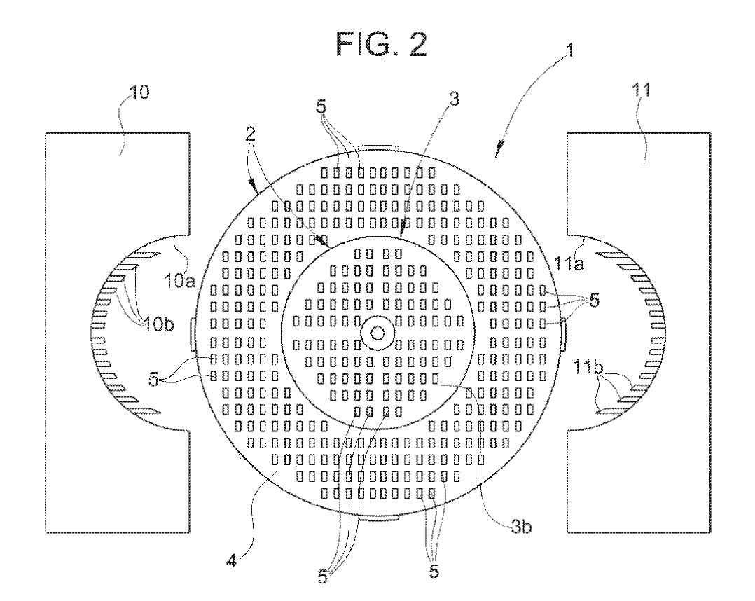

The body 2 has a hollow central portion 3, in the shape of a cup, the axis of which is indicated by A-A in FIG. 1.

The body 2 of the filter also has an annular plate-like peripheral portion 4, essentially shaped as a flange, extending radially towards the outside around the open end of the central cup-shaped portion 3.

In the embodiment illustrated in the drawings, the central cup-shaped part 3 of the filter has an essentially frusto-conical lateral wall 3a.

On the side opposite to the peripheral flange-like portion 4, the frusto-conical lateral wall 3a is closed by a planar end wall 3b parallel to the peripheral portion 4.

The peripheral flange-like portion 4 and the planar end wall 3b of the filter have respective pluralities of through holes 5, essentially parallel to the axis A-A of the filter.

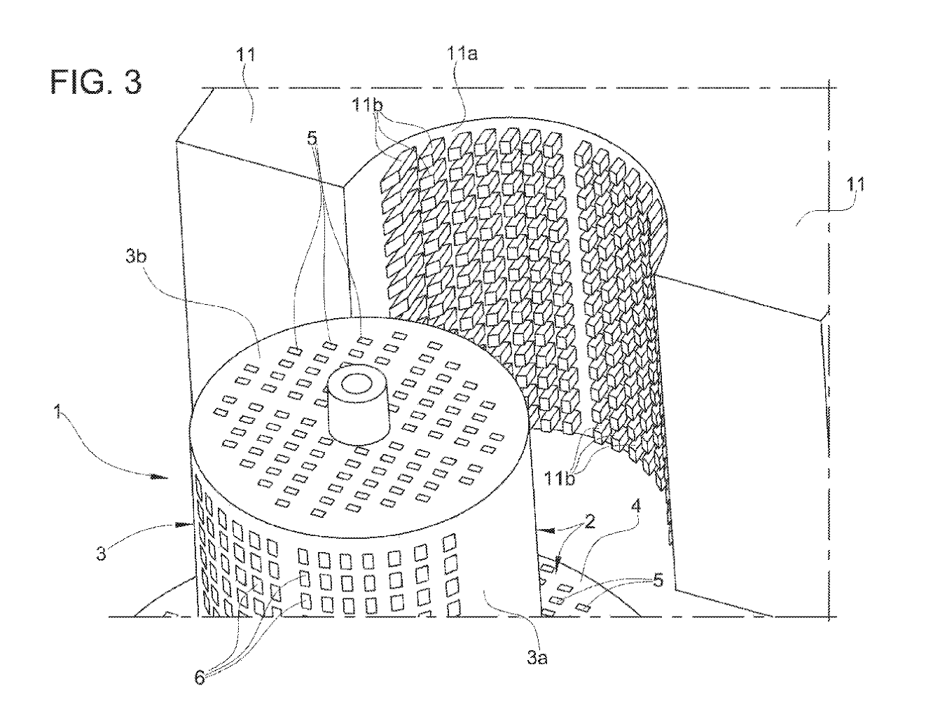

In the lateral wall 3a of the central portion there is provided a plurality of through holes 6, the axes of which line in planes which are essentially transverse with respect to the axis A-A of the filter (see, in particular, FIGS. 1 and 3).

Said through holes 6 are conveniently all parallel to each other and to a diameter of the lateral wall 3a.

This characteristic greatly simplifies the devices required for the injection moulding of the filter 1, and in particular for the forming of its central portion 3 and of the lateral wall 3a thereof.

This is because, as shown in the drawings, only two moving carriages, such as those indicated by 10 and 11 in the drawings, are required for forming the lateral wall 3a, together with an essentially frusto-conical inner core (not shown).

The two carriages 10 and 11 have respective cavities 10a and 11a, which face each other when in use. In these cavities there extend respective arrays of protuberances 10b and 11b which are parallel to each other, and which are designed to form the through holes 6 in the lateral wall 3a of the central portion 3 of the filter. As a general rule, the protuberances 10b and 11b differ in their longitudinal extension, according to their angular positions, and have curved end surfaces which are complementary to a corresponding ring on the outer surface of the core designed to form the inner cavity of the central cup-shaped portion 3 of the filter.

The carriages 10 and 11 are positioned opposite each other and can be moved towards and away from each other along a single path.

Conveniently, both the through holes 5 and the through holes 6 of the filter 1 have a cross section which is essentially quadrangular, and preferably rectangular.

Although the central cup-shaped portion 3 of the filter 1 shown in the drawings is essentially frusto-conical, in other possible embodiments (not shown) this central portion of the filter could be frusto-pyramidal, cylindrical, or prismatic in shape.

In other possible embodiments which are not shown, the central cup-shaped part 3 of the filter can be essentially conical or pyramidal in shape.

Experiments have shown that, for optimal operation of a filter of the type described above, the average diameter of the central cup-shaped portion 3 should be comprised between about 0.4 and about 0.8 times the diameter of the peripheral flange-like portion 4, that is to say the diameter of the conduit in which the filter is positioned when in use, and this holds true for practically any axial extension of the central portion 3.

On the basis of these results it is possible to give a “theoretical” proof, as described below.

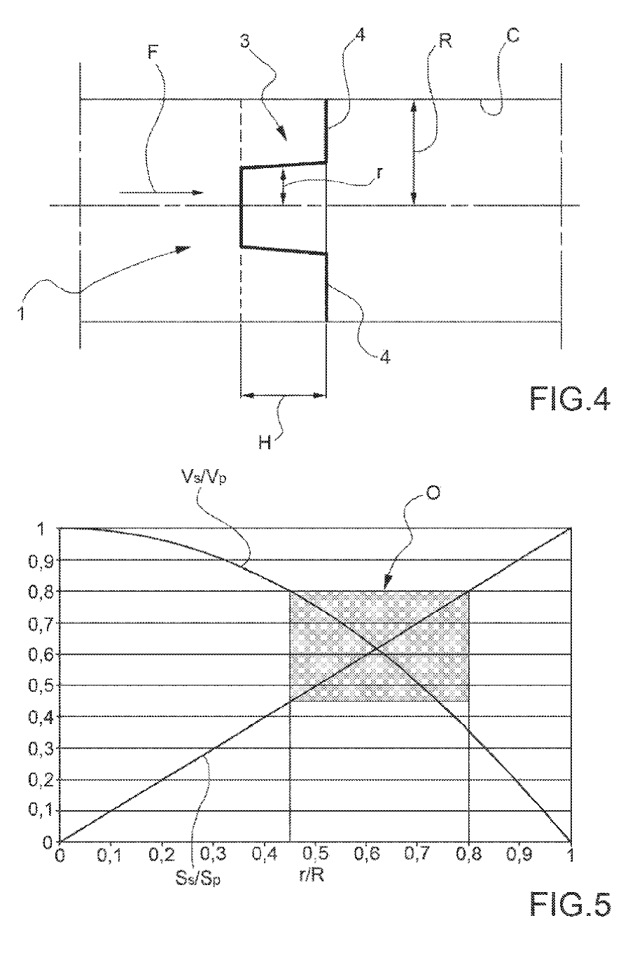

A mathematical description providing a first approximation of a filter 1 according to the invention will now be given with reference to FIG. 4.

FIG. 4 is a schematic illustration of a circular cylindrical conduit C having a radius R, in which is placed a filter 1 as described above, the central cup-shaped portion 3 of the filter having an axial length H and an average radius r<R.

The direction of the flow of liquid to be filtered during operation is indicated by the arrow F.

If Vₚ denotes the maximum volume that the central part 3 of the filter can occupy when r and H vary, we find that:

Vₚ=πHR² (1).

Also, if V_{f} denotes the volume occupied by the central portion 3 (assumed to have a circular cylindrical shape), we find that:

V_{f}=πHr² (2).

Then, if Sₚ denotes the maximum surface area of the central portion 3 (assumed to have a circular cylindrical shape), we find that:

Sₚ=2πHR (3).

Finally, if S_{f} denotes the surface area of the central part 3 (assumed to have a circular cylindrical shape), then we also find that:

S_{f}=2πHr (4).

In the filter 1, the volume Vₛ available for the sedimentation of the retained particulate matter is:

Vₛ=Vₚ−V_{f}=πR(R²−r²) (5).

From equations (5) and (1) above it follows that:

$${V}_{s} / {V}_{p} = 1 - \frac{{r}^{2}}{{R}^{2}} . \qquad ( 6 )$$

Also, from equations (4) and (3) it follows that:

$${S}_{f} / {S}_{p} = \frac{r}{P} . \qquad 7 )$$

FIG. 5 shows the variations of the ratios Vₛ/Vₚ and S_{f}/Sₚ as functions of the ratio r/R shown on the horizontal axis.

Clearly, these ratios vary in opposite directions. It is also possible to identify an area, such as that indicated by 0, in which the aforesaid ratios (or coefficients of volume and surface area respectively) are optimal.

This area corresponds to an optimal range of values of the ratio r/R comprised between about 0.45 and 0.80.

This result is substantially in agreement with the experimental findings described above.

In the case of non-circular transverse geometries, the above findings remain valid in relation to the average transverse dimensions of the conduit and of the central part of the filter.

It has also been found that, if the axial length H of the central portion 3 of the filter 1 is substantially equal to or greater than 0.7 times the average radial dimension R of the conduit C, there is an optimal distribution of the particulate matter retained downstream of the filter 1, which is distributed with a “slope” related to the angle of friction of this particulate matter, leaving a considerable surface area free in the upper peripheral area of the filter.

Naturally, the principle of the invention remaining the same, the forms of embodiment and the details of construction may be varied widely with respect to those described and illustrated, which have been given purely by way of non-limiting example, without thereby departing from the scope of the invention as defined in the attached claims.

What is claimed is:

1. A conduit (C) for liquids including a filter (1) placed in the conduit (C), the conduit (C) having a radius (R) and the filter (1) comprising a body of moulded plastic material including:
a central hollow portion (3) shaped like a cup, having a central axis (A-A) and a circular annular cross-section taken transverse to the central axis (A-A), and
a peripheral plate-like portion (4), shaped as a circular flange, extending radially outward around an open end of the central hollow portion (3), wherein
in a lateral wall (3a) of the central hollow portion (3) there is provided a plurality of first through holes (6), essentially transverse with respect to the central axis (A-A),
in the peripheral plate-like portion (4) there is provided a plurality of second through holes (5) essentially parallel to the central axis (A-A),
the first through holes (6) provided in the lateral wall (3a) of the central hollow portion (3) are all parallel to each other in a circumferential direction of the central hollow portion (3) and in a direction along the central axis (A-A), and
the peripheral plate-like portion (4) has a radius (R) measured from the central axis (A-A) of the central hollow portion (3), and the central hollow portion (3) has a radius (r) measured from the central axis (A-A) of the central hollow portion (3), wherein the radius (R) of the peripheral plate-like portion (4) is equal to the radius of the conduit (C) and the radius (r) of the central hollow portion (3) of the filter (1) is between 0.4 and 0.8 times the radius (R) of the peripheral plate-like portion (4).

2. The conduit for liquids according to claim 1, wherein the lateral wall (3a) of the central hollow portion (3) is essentially frusto-conical or cylindrical, and on the side opposite to the peripheral plate-like portion (4) is closed by a planar end wall (3b) parallel to the peripheral plate-like portion (4); the end wall (3b) being provided with a plurality of through holes (5) essentially parallel to the central axis (A-A).

3. The conduit for liquids according to claim 1, wherein the central hollow portion (3) has an essentially conical shape.

4. The conduit for liquids according to claim 1, wherein the first through holes (6) and the second through holes (5) have an essentially quadrangular cross section.

5. The conduit for liquids according to claim 4, wherein the first through holes (6) and the second through holes (5) have an essentially rectangular cross section.

6. The conduit for liquids according to claim 1, wherein an axial length (H) of the central hollow portion (3) is greater than or equal to about 0.7 times the radius (R) of the peripheral plate-like portion (4).

7. The conduit for liquids according to claim 1, wherein a ratio of the radius (r) of the central hollow portion (3) to the radius (R) of the peripheral plate-like portion (4) is maintained about a circumference of the central hollow portion (3).

8. The conduit for liquids according to claim 1, wherein the filter (1) is an inlet filter (1) for hydraulic electric valves for use in household appliances and the like.

9. A method of making a filter for liquids of claim 1, comprising the steps of:
using two moulding carriages, each having respective cavities which face each other, each cavity having a plurality of protuberances which are arranged in an array and parallel to each other;
moving the two moulding carriages towards each other and towards the central hollow portion,
using the plurality of protuberances arranged in the array to form the plurality of through holes in the lateral wall.

10. The method of making the filter for liquids according to claim 6, wherein a length of each protuberance of the plurality of protuberances in a radial direction corresponds to an angular position of each protuberance.
